(19) United States
(12) Patent Application Publication
(10) Pub. No.: US 2021/0237505 A1
(43) Pub. Date: Aug. 5, 2021

(54) ART CANVAS WITH BUILT-IN FOLDABLE FRAME

(71) Applicant: Arteza Inc., Wilmington, DE (US)

(72) Inventor: Mykhalio Koshatko, Wilmington, DE (US)

(73) Assignee: Arteza Inc., Wilmington, DE (US)

(21) Appl. No.: 17/167,123

(22) Filed: Feb. 4, 2021

Related U.S. Application Data
(60) Provisional application No. 62/969,788, filed on Feb. 4, 2020.

(51) Int. Cl. B44D 3/18

(52) U.S. Cl. CPC B44D 3/185

(57) ABSTRACT

An integrated canvas and frame includes a substantially planar sheet having a first plurality of channels and a second plurality of channel formed therein. The first plurality of channels extends along a first axis and the second plurality of channels extends along a second axis. Each channel extends from a first planar surface of the substantially planar sheet into the substantially planar sheet. A plurality of corner sections are configured to be detached from the substantially planar sheet to define one or more foldable portions. The foldable portions defines a subset of the first plurality of channels or a subset of the second plurality of channels. A first plurality of internal perforations is formed in at least one of the one or more foldable portions. The plurality of internal perforations define one or more coupling features configured to retain the one or more foldable portions in a folded position.

### CROSS-REFERENCE TO RELATED APPLICATION

This application claims benefit to U.S. Provisional Application Ser. No. 62/969,788, filed Feb. 4, 2020, and entitled “Art Canvas with Built-In Foldable Frame,” the entirety of which is incorporated herein by reference.

### BACKGROUND

Traditional presentation of artwork includes placing a finished piece, such as a painted canvas, page, or other medium, within a separate frame. The process of framing the artwork requires skills other than those necessary for creating the initial artwork. Traditional framing requires multiple steps including matting the work, fixing the work to the mat, centering the work in the frame, and affixing the mat to the frame.

In some instances, the cost of frames, availability of storage space for frame materials, or other considerations means that works created by amateur or at-home artist are not typically framed. Artwork created at home may not utilize the proper materials, dimensions, or other aspects for framing. In other instances, the prolific nature of at home art, such as that produced by children, may make framing each work improbable.

### SUMMARY

In various embodiments, an integrated canvas and frame is disclosed. The integrated canvas and frame includes a substantially planar sheet having a first plurality of channels and a second plurality of channel formed therein. The first plurality of channels extends substantially along a first axis and the second plurality of channels extends substantially along a second axis. Each channel in the plurality of channels extends from a first planar surface of the substantially planar sheet into the substantially planar sheet. A plurality of perforations define a plurality of corner sections. Each corner section in the plurality of corner sections is configured to be detached from the substantially planar sheet to define one or more foldable portions of the substantially planar sheet. Each of the one or more foldable portions defines a subset of the first plurality of channels or a subset of the second plurality of channels. A plurality of internal perforations is formed in at least one of the one or more foldable portions. The plurality of internal perforations define one or more coupling features configured to retain the one or more foldable portions in a folded position.

In various embodiments, an integrated canvas and frame is disclosed. The integrated canvas and frame includes a substantially planar sheet defined by at least a first edge, a second edge, a third edge, and a fourth edge. The first edge and the second edge extend substantially along a first axis and the third edge and the fourth edge extend substantially along a second axis. A first set of channels is formed adjacent to the first edge. The first set of channels includes a first channel positioned a first distance from the first edge, a second channel positioned a second distance from the first channel, a third channel positioned the first distance from the second channel, and a fourth channel positioned the second distance from the third channel. Each of the first channel, the second channel, the third channel, and the fourth channel extend substantially along the first axis. A second set of channels is formed adjacent to the second edge. The second set of channels includes a fifth channel positioned the first distance from the second edge, a sixth channel positioned the second distance from the fifth channel, a seventh channel positioned the first distance from the sixth channel, and an eighth channel positioned the second distance from the fourth channel. Each of the fifth channel, the sixth channel, the seventh channel, and the eighth channel extend substantially along the first axis. A third set of channels is formed adjacent to the third edge. The third set of channels includes a ninth channel positioned a third distance from the third edge, a tenth channel positioned a fourth distance from the ninth channel, and an eleventh channel positioned the third distance from the tenth channel. Each of the ninth channel, the tenth channel, and the eleventh channel extend substantially along the second axis. A fourth set of channels is formed adjacent to the fourth edge. The fourth set of channels includes a twelfth channel positioned the third distance from the third edge, a thirteenth channel positioned the fourth distance from the twelfth channel, and a fourteenth channel positioned the third distance from the thirteenth channel. Each of the twelfth channel, the thirteenth channel, and the fourteenth channel extend substantially along the second axis. Each of the first set of channels, the second set of channels, the third set of channels, and the fourth set of channels define positions at which a portion of the substantially planar surface can be transitioned from a first, planar configuration to a second configuration defining one or more cuboids.

In various embodiments, a method is disclosed. The method includes a step of obtaining a substantially planar sheet having a first plurality of channels and a second plurality of channel formed therein. The first plurality of channels extends substantially along a first axis and the second plurality of channels extends substantially along a second axis. Each channel in the plurality of channels extends from a first planar surface of the substantially planar sheet into the substantially planar sheet. The method further includes separating a plurality of corner portions from the substantially planar sheet to expose a plurality of foldable portions and transitioning each of the plurality of foldable portions to a folded configuration in which each of the plurality of foldable portions defines a three-dimensional shape. Each of the plurality of foldable portions includes a subset of the first plurality of channels or a subset of the second plurality of channels and is transitioned to the folded configuration by folding a respective foldable portion at each channel in the subset of the first plurality of channels or the subset of the second plurality of channels included in the respective foldable portion. The method further includes coupling two or more of the plurality of foldable portions to maintain each of the plurality of foldable portions in the folded configuration.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a planer view of an integrated canvas and frame in a first configuration, in accordance with some embodiments.

FIG. 2 illustrates the integrated canvas and frame of FIG. 1 having each of a plurality of perforated corners removed therefrom, in accordance with some embodiments.

FIG. 3 illustrates the integrated canvas and frame of FIG. 2 having a first set of opposite sides in a folded state, in accordance with some embodiments.

FIG. 4 illustrates the integrated canvas and frame of FIG. 3 having a first side of a second set of opposite sides in a folded state, in accordance with some embodiments.

FIG. 5 illustrates the integrated canvas and frame of FIG. 4 in a second configuration, in accordance with some embodiments.

FIG. 6 is a flowchart illustrating a method of converting an integrated canvas and frame from a first configuration to a second configuration, in accordance with some embodiments.

### DETAILED DESCRIPTION

The description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship.

In various embodiments, an integrated canvas and frame is disclosed. The integrated canvas and frame is configured to be transitioned from a first configuration defining a flat working surface to a second configuration including a frame defining an inset. The integrated canvas and frame includes a sheet of material defining a set of perforations and a set of channels (or creases) formed in the material. The set of perforations define removable portions of the sheet. The set of channels define portions of the sheet configured to be transitioned out of the plane defined by the majority of the sheet of material (e.g., folded). The integrated canvas and frame defines one or more openings sized and configured to receive a connecting element therein. The connecting element is defined by one or more of the perforations in the set of perforations and/or one or more channels in the set of channels. The integrated canvas and frame is configured to be transitioned from the first configuration to the second configuration by removing one or more removable portions of the sheet and folding one or more portions of the sheet along the set of channels.

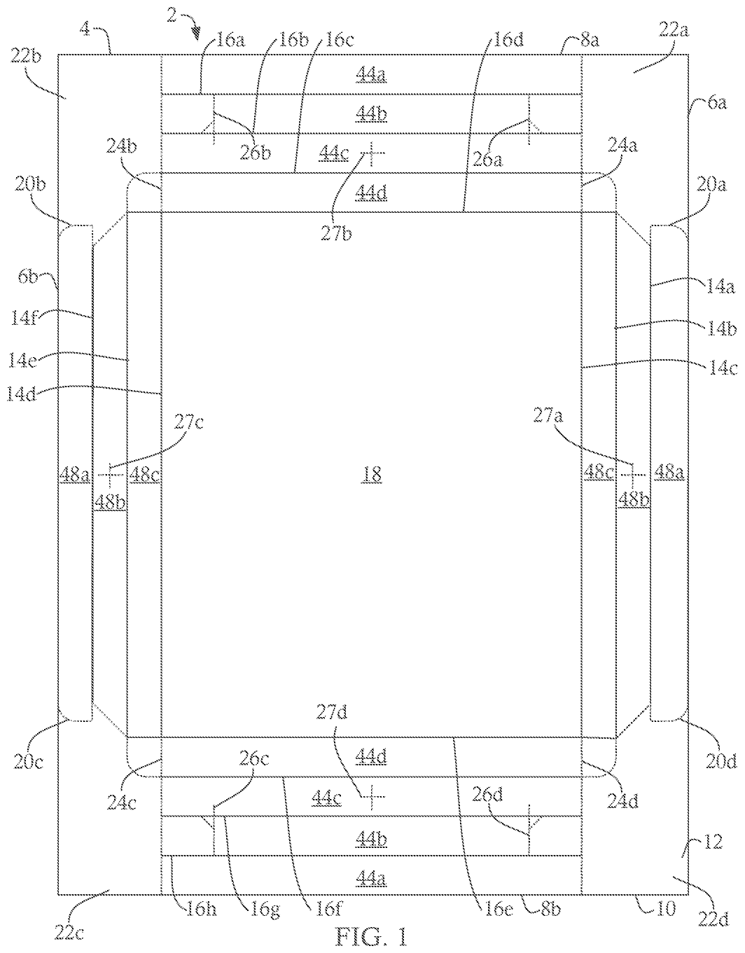

FIG. 1 illustrates an integrated canvas and frame 2 in a first configuration, in accordance with some embodiments. In the first configuration, the integrated canvas and frame 2 includes a substantially planar sheet 4 having parallel vertical edges 6a, 6b (referred to collectively as “vertical edges 6”) extending substantially along a first axis (referred to herein as the “Y-axis”) and parallel horizontal edges 8a, 8b (referred to collectively as “parallel horizontal edges 8”) extending substantially along a second axis (referred to herein as the “X-axis”). The parallel vertical edges 6 and the parallel horizontal edges 8 define a rectangular outer perimeter 10 of the substantially planar sheet 4. Although embodiments are discussed herein including a rectangular outer perimeter 10, it will be appreciated that outer perimeter 10 of the substantially planar sheet 4 may define any suitable regular and/or irregular geometric shape, such as, for example, a square, a rectangle, a parallelogram, a rhombus, a pentagon, a hexagon, etc.

The substantially planar sheet 4 includes a first planar surface 12 and a second planar surface (not shown). In some embodiments, the first planar surface 12 defines a plurality of vertical channels 14a-14f (referred to collectively as “vertical channels 14”) extending substantially parallel to the vertical edges 6 (e.g., along the Y-axis) and a plurality of horizontal channels 16a-16h (referred to collectively as “horizontal channels 16”) extending substantially parallel to the horizontal edges 8 (e.g., along the X-axis) of the substantially planar sheet 4. In some embodiments, one or more of the vertical channels 14 and/or the horizontal channels 16 may extend to an edge of the substantially planar sheet 4 such that one or more vertical channels and one or more horizontal channels intersect. In the illustrated embodiments, the vertical channels 14 and the horizontal channels 16 terminate at one or more corner perforations 20a-20d and do not intersect, although it will be appreciated that the channels 14, 16 may extend to the edges of the substantially planar sheet 4 and/or may intersect. Although embodiments are discussed herein including vertical channels 14 and horizontal channels 16, it will be appreciated that channels may extend in any suitable direction and at any suitable angle with respect to one or more edges 6, 8 of the substantially planar sheet 4 so as to provide any suitable shape to the frame portion of the integrated canvas and frame 2 in the second configuration, as discussed in greater detail below.

In some embodiments, the vertical channels 14 include a first subset of vertical channels (e.g., vertical channels 14a-14c) located adjacent to a first vertical edge 6a and a second subset of vertical channels (e.g., vertical channels 14d-14f) located adjacent to a second vertical edge 6b. In the illustrated embodiment, each of the vertical channels in a subset of channels is located at a consistent distance from one of the vertical edges 6 and/or another channel in the set of channels. For example, in the illustrated embodiment, a first subset includes three vertical channels 14a-14c. A first vertical channel 14a is located at a predetermined distance X from a first vertical edge 6a of the substantially planar sheet 4. A second vertical channel 14b is located the same predetermined distance X from the first vertical channel 14a (and a predetermined distance 2X from the first vertical edge 6a). A third vertical channel 14c is located the same predetermined distance X from the second vertical channel 14b (and a predetermined distance 3X from the first vertical edge 6a). By arranging three vertical channels 14a-14c at equal distances, the first subset of vertical channels 14a-14c is configured to define a cuboid having a square cross-section when arranged in the second configuration (as discussed in greater detail below). Although embodiments are discussed herein including channels configured to define a square cuboid, it will be appreciated that the channels may be arranged to define any suitable three-dimensional shape in the second configuration. For example, in various embodiments, each subset of channels may be configured to define any suitable three-dimensional shape such as a triangular prism, a cuboid, an octagonal prism, and/or any other suitable shape. As one example, and without limitation, in some embodiments, a distance between a first vertical channel 14a and a second vertical channel 14b (X₂) may be less than and/or greater than the distance between the first edge 6a and the first vertical channel 14a (X₁) and the distance between the second vertical channel 14b and the third vertical channel 14c (X₃), where X₁=X₃, such that the vertical channels are configured to define a cuboid having a rectangular cross-sectional shape. It will be appreciated that any number of variations may be used for spacing between any of the channels 14, 16 to define various edge shapes.

In some embodiments, the second subset of vertical channels 14d-14f have a similar arrangement with respect to the second vertical edge 6b as that described for the first subset of vertical channels 14a-14c with respect to the first vertical edge 6a. For example, in the illustrated embodiment, a sixth vertical channel 14f is located at the predetermined distance X from the second vertical edge 6b, a fifth vertical channel 14e is located at the predetermined distance X from the sixth vertical channel 14f (and a predetermined distance 2X from the second vertical edge 6b), and a fourth vertical channel 14d is located at the predetermined distance X from the fifth vertical channel 14e (and a predetermined distance 3X from the second vertical edge 6b). Although embodiments are discussed herein in which the subsets of channels (e.g., channels 14a-14c and channels 14d-14f) have similar spacing arrangements, it will be appreciated that each subset of vertical channels may have different spacing.

In some embodiments, the horizontal channels 16 include a first subset of horizontal channels (e.g., horizontal channels 16a-16d) located adjacent to a first horizontal edge 8a and a second subset of channels (e.g., channels 16e-16h) located adjacent to a second horizontal channel 8b. In the illustrated embodiment, each of the horizontal channels in a subset of channels is located at a consistent distance from one of the horizontal edges 6 and/or another channel in the set of channels. For example, in the illustrated embodiment, a first subset includes four horizontal channels 16a-16d. A first horizontal channel 16a is located at a predetermined distance X from a first horizontal edge 8a of the substantially planar sheet 4. A second horizontal channel 16b is located the same predetermined distance X from the first horizontal channel 16a (and a predetermined distance 2X from the first horizontal edge 8a). A third horizontal channel 16c is located the same predetermined distance X from the second horizontal channel 16b (and a predetermined distance 3X from the first horizontal edge 8a). A fourth horizontal channel 16d is located the same predetermined distance X from the third horizontal channel 16c (and a predetermined distance 4X from the first horizontal edge 8a). By arranging four horizontal channels 16a-16d at equal distances, the first subset of horizontal channels 16a-16d is configured to define a cuboid having a square cross-section when arranged in the second configuration (as discussed in greater detail below) including a bottom face that overlaps a second portion of the substantially planar sheet 4 (such as the inner planar area 18 discussed below. Although embodiments are discussed herein including channels configured to define a cuboid, it will be appreciated that the channels may be arranged to define any suitable three-dimensional shape in the second configuration. For example, in various embodiments, each subset of channels may be configured to define any suitable three-dimensional shape such as a triangular prism, a cuboid, an octagonal prism, and/or any other suitable shape. Similar to the vertical channels 14, each subset of the horizontal channels 16 may be configured to define any suitable three-dimensional shape such as a triangular prism, a cuboid, an octagonal prism, and/or any other suitable shape. As one example, and without limitation, in some embodiments, a distance (X₂) between a first horizontal channel 16a and a second horizontal channel 16b and the distance (X₄) between a third horizontal channel 16c and a fourth horizontal channel 16d may be less than and/or greater than the distance between the first horizontal edge 8a and the first horizontal channel 16a (X₁) and the distance between the second vertical channel 14b and the third vertical channel 16c (X₃), where X₁=X₃ and X₂=X₄, such that the horizontal channels 16 are configured to define a cuboid having a rectangular cross-sectional shape. It will be appreciated that any number of variations may be used for spacing between any of the channels 14, 16 to define various edge shapes.

In some embodiments, the second subset of horizontal channels 16e-16h have a similar arrangement with respect to the second horizontal edge 8b as that described for the first subset of horizontal channels 16a-16d with respect to the first horizontal edge 8a. For example, in the illustrated embodiment, an eighth horizontal channel 16h is located at the predetermined distance X from the second horizontal edge 8b, a seventh horizontal channel 16g is located at the predetermined distance X from the eighth horizontal channel 16h (and a predetermined distance 2X from the second horizontal edge 8b), a sixth horizontal channel 16f is located at the predetermined distance X from the seventh horizontal channel 16g (and a predetermined distance 3X from the second horizontal edge 8b), and a fifth horizontal channel 16e is located at the predetermined distance X from the sixth horizontal channel 16f (and a predetermined distance 4X from the second horizontal edge 8b). Although embodiments are discussed herein in which the subsets of channels (e.g., channels 16a-16d and channels 16e-16h) have similar spacing arrangements, it will be appreciated that each subset of horizontal channels may have different spacing.

In some embodiments, a set of innermost channels 14c, 14d, 16d, 16e collectively define an inner planar area 18. The inner planar area 18 includes a portion of the integrated canvas and frame 2 that maintains a consistent state (e.g., planar) when the integrated canvas and frame 2 is transitioned from a first configuration to a second configuration. As discussed in greater detail below, the inner planar area 18 includes a portion of the integrated canvas and frame 2 that is positioned within the “frame,” or within an inset, of the integrated canvas and frame 2 in the second configuration.

In some embodiments, the inner planar area 18 and/or other portions of the first planar surface 12 may be configured to receive a medium thereon. For example, in various embodiments, inner planar area 18 defines a working area configured to receive a medium, such as paint, marker, pencils, etc., thereon. The inner planar area 18 and/or other portions of the first planar surface 12 may be configured to receive a medium prior to, during, and/or after the substantially planar sheet 4 has been transitioned from the first configuration to the second configuration. In some embodiments, the second planar surface (not shown) is configured to receive a medium thereon. The medium may include any suitable medium (e.g., paint, marker, pencil, etc.) applied prior to, during, and/or after transition from the first configuration to the second configuration.

In some embodiments, each of the vertical channels 14 and/or the horizontal channels 16 define a tapered channel extending into the substantially planar sheet 4. For example, in some embodiments, each of the channels 14, 16 defines an opening extending a predetermined depth into the substantially planar sheet 4 and tapering from a widest point at a top (i.e., the portion of the channel in-plane with the planar surface 12) to a narrowest point at the bottom (i.e., a bottom surface of the respective channel 14, 16).

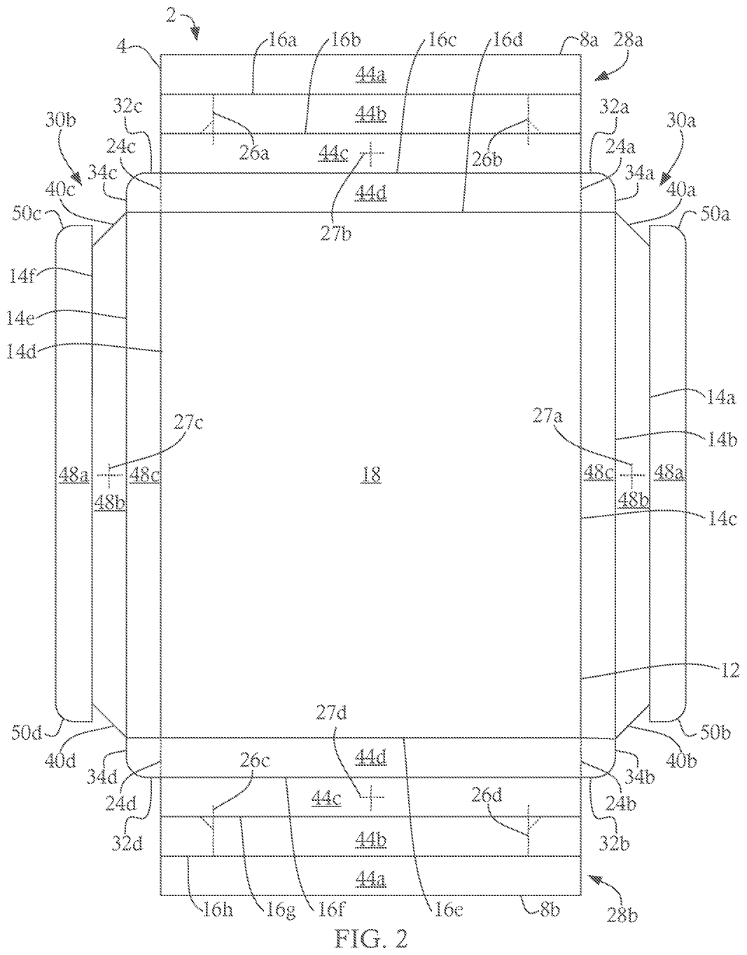

In some embodiments, the substantially planar sheet 4 includes a plurality of corner perforations 20a-20d (referred to collectively as “corner perforations 20”). The corner perforations 20 each define a corner portion 22a-22d (referred to collectively as “corner portions 22”) of the substantially planar sheet 4 that is configured to be removed. In the illustrated embodiment, each of the corner perforations 20 defines a continuous line that extends from one of the vertical edges 6 to one of the horizontal edges 8. In some embodiments, the corner perforations 20 define elements of the integrated canvas and frame 2 that are defined only once the corner portions 22 are removed, as discussed in greater detail with respect to FIG. 2.

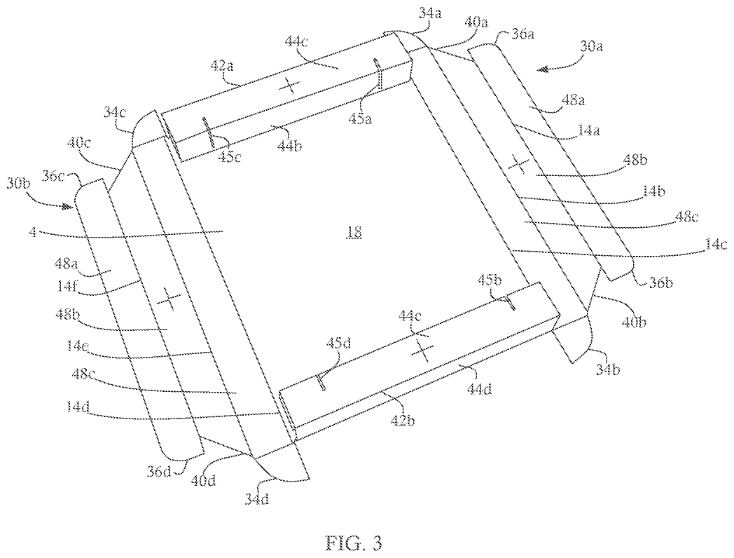

In some embodiments, the substantially planar sheet 4 includes one or more internal perforations 24a-24d, 26a-26d. The internal perforations 24a-24d, 26a-26d define portions of the substantially planar sheet 4 that are configured to be cut or opened to define an opening extending through the substantially planar sheet 4 from the first planar surface 12 to a second planar surface. In some embodiments, a first set of internal perforations 24a-24d are configured to separate a first portion of the substantially planar sheet 4 from a second portion of the substantially planar sheet 4. For example, in the illustrated embodiment (and as discussed in greater detail with respect to FIGS. 3-5), a set of internal perforations 24a-24d define a portion of the substantially planar sheet 4 configured to define a semicircular tab configured to be received within a cuboid defined by a foldable section. As another example, in some embodiments, a set of internal perforation 26a-26d define slots in the foldable portions of the substantially planar surface 4 configured to be used for forming a frame portion (as discussed in greater detail with respect to FIGS. 3-5).

In some embodiments, a set of internal perforations 27a-27d define mounting features configured to allow the integrated canvas and frame 2 to be mounted to a separate surface, such as a wall, after conversion from the first configuration to the second configuration. For example, in the illustrated embodiment, a set of internal perforations 27a-27d define crosses or X's configured to receive a mounting element therein to mount the integrated canvas and frame 2 to a wall after converting the integrated canvas and frame 2 to the second configuration. Although embodiments are discussed herein with specific configurations of internal perforations 24a-24d, 26a-26d, 27a-27d, it will be appreciated that the substantially planar sheet 4 can define any number of perforations and/or openings extending therethrough.

FIG. 2 illustrates the integrated canvas and frame 2 of FIG. 1 having each of the corner portions 22 removed along the perforated lines 20, in accordance with some embodiments. As shown in FIG. 2, removing the corner portions 22 defines two vertical foldable portions 28a, 28b and two horizontal foldable portions 30a, 30b. The vertical foldable portions 28a, 28b include the portion of the substantial planar sheet 4 that includes one or more of the vertical channels 14 and the horizontal foldable portions 30a, 30b include the portion of the substantial planar sheet 4 that includes one or more of the horizontal channels 16. As shown in FIG. 2, the location of the corner perforations 20 in FIG. 1 now define solid edges 32a-32d of the substantially planar sheet 4.

In some embodiments, removing the corner portions 22 at least partially defines one or more additional elements of the substantially planar sheet 4. For example, in the illustrated embodiment, removal of the corner portions 22 causes a plurality of semicircular tabs 34a-34d to be defined by the new edge 32a-32b and a portion of the horizontal foldable sections 28a, 28b. In the illustrated embodiment, an internal perforation 24a-24d allows each semicircular tab 34a-34d to be removed from an adjacent vertical foldable section 30a, 30b. Once removed from the adjacent vertical foldable section 30a, 30b, each semicircular tab 34a-34d may be bent out-of-plane with respect to the planar surface 12, as discussed in greater detail below with respect to FIGS. 3-5.

In some embodiments, the corner perforations 20 are configured such that removal of the corner portions 22 defines a rounded corner 36a-36d at each end of a first horizontal foldable section 38a, 38b and/or an angled portion 40a-40d at each end of a second horizontal foldable section 42a, 42b. As discussed in greater detail below with respect to FIGS. 3-5, the rounded corners 36a-36d and the angled portion 40a-40d are configured allow a cuboid to be defined by the vertical foldable portions 28a, 28b to be positioned adjacent to and/or coupled to a cuboid defined by the horizontal foldable portions 30a, 30b.

FIG. 3 illustrates the integrated canvas and frame 2 of FIG. 2 having each of the horizontal foldable portions 30a, 30b in a folded state, in accordance with some embodiments. As shown in FIG. 3, the horizontal foldable portions 30a, 30b be folded at each of the vertical channels 16a-16d, 16e-16h such that the horizontal foldable portions 30a, 30b define vertical cuboids 42a, 42b, The vertical cuboids 42a, 42b extend above the planar surface 12 defined by the remainder of the substantially planar sheet 4 (e.g., the plane defined by the inner planar area 18). Each of the vertical cuboids 42a, 42b overlap a portion of the substantially planar sheet 4.

In the illustrated embodiment, the horizontal foldable portions 30a, 30b include foldable sections configured to be positioned at right (e.g., 90°) angles when in the folded position. Although embodiments are discussed herein including a cuboid shape, it will be appreciated that the foldable sections of the horizontal foldable portions 30a, 30b may be configured to define any suitable angle therebetween and/or to define any suitable three dimensional shape.

To transition each of the horizontal foldable portions 30a, 30b to vertical cuboids 42a, 42b, each of the vertical foldable sections 44a-44d of each of the horizontal foldable portions 30a, 30b is folded at a predetermined angle relative to the next vertical foldable section 44a-44d and/or relative to the first planar surface 12. For example, in the illustrated embodiment, each horizontal foldable portion 30a, 30b, is transitioned to a vertical cuboid by folding each of the vertical foldable sections 44a-44d at a 90° angle relative to the next vertical foldable section 44a-44d and/or relative to the first planar surface. Although embodiments are illustrated herein including a 90° fold configured to form a cuboid, it will be appreciated that the relevant angle between each vertical foldable section 44a-44d and/or the planar surface 12 may include any suitable angle, such as, for example, any angle between 0° and 180°.

As shown in FIG. 3, in some embodiments, each of the vertical cuboids 42a, 42b define a plurality of slots 45a-45d. In some embodiments, the slots 45a-45d are defined by removal and/or opening of an internal perforation defined by the substantially planar sheet 4. For example, in the illustrated embodiment, the plurality of slots 45a-45d in the cuboids 42a, 42b correspond to the plurality of internal perforations 26a-26d defined in the substantially planar sheet 4 (as shown in FIGS. 1 and 2). The internal perforations 26a-26d are removed and/or separated to define the plurality of slots 45a-45d prior to, simultaneous with, and/or after forming a cuboid 42a, 42b from the respective horizontal foldable portions 30a, 30b. Although embodiments are illustrated herein including a plurality of slots 45a-45d defined by internal perforations 26a-26d, it will be appreciated that the substantially planar surface 4 may define openings (without perforations) corresponding to the plurality of slots 45a-45d.

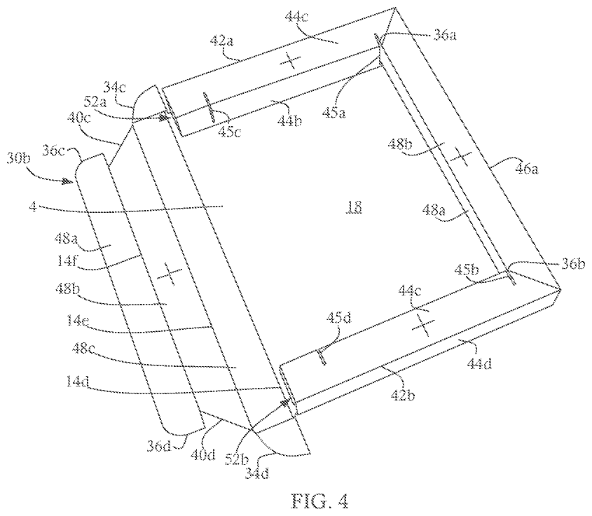

FIG. 4 illustrates the integrated canvas and frame 2 of FIG. 3 having a first vertical foldable portion 28a in a folded state, in accordance with some embodiments. As illustrated in FIG. 4, the first vertical foldable portion 28a is folded at each of the horizontal channels 14a-14c such that the first vertical foldable portion 28a defines a horizontal cuboids 46a. The horizontal cuboid 46a extends above the planar surface 12 defined by the remainder of the substantially planar sheet 4 (e.g., the plane defined by the internal working area 18). The horizontal cuboids 46a overlaps a portion of the substantially planar sheet 4 and, in the illustrated embodiment, the substantially planar sheet 4 defines a bottom surface of the horizontal cuboid 46a.

In the illustrated embodiment, the first vertical foldable portion 28a includes foldable sections configured to be positioned at right (e.g., 90°) angles when in the folded position. Although embodiments are discussed herein including a cuboid shape, it will be appreciated that the foldable sections of the vertical foldable portions 28a, 28b may be configured to define any suitable angle therebetween and/or to define any suitable three dimensional shape.

To transition the first vertical foldable portion 28a to horizontal cuboid 46a, each of the horizontal foldable sections 48a-48c of the first vertical foldable portion 28a is folded at a predetermined angle relative to the next horizontal foldable section 48a-48c and/or relative to the first planar surface 12. For example, in the illustrated embodiment, the first vertical foldable portion 28a is transitioned to a horizontal cuboid by folding each of the horizontal foldable sections 48a-48c at a 90° angle relative to the next horizontal foldable section 48a-48c and/or relative to the first planar surface 12. Although embodiments are illustrated herein including a 90° fold configured to form a cuboid, it will be appreciated that the relevant angle between each horizontal foldable section 48a-48c and/or the planar surface 12 may include any suitable angle, such as, for example, any angle between 0° and 180°.

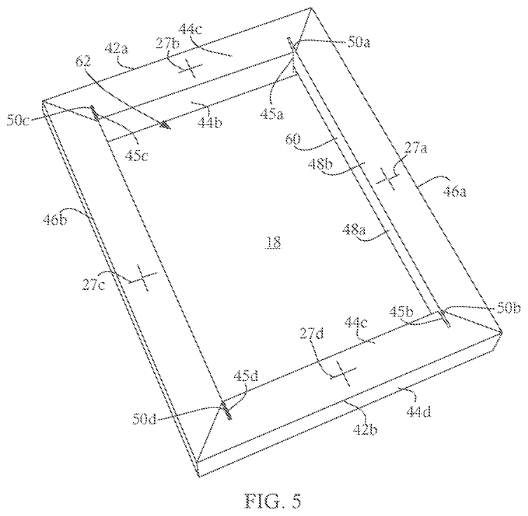

With reference to FIGS. 3 and 4, when transitioning the first vertical foldable portion 28a to the first horizontal cuboid 46a, semicircular tabs 34a, 34b may be inserted into each of the vertical cuboids 42a, 42b. For example, as can be seen in FIGS. 3-4, the vertical cuboids 42a, 42b are hollow, having an inner space 52a, 52b defined by the vertical foldable sections 44a-44h. The semicircular tabs 34a, 34b coupled to the first horizontal foldable portion 30a are folded out-of-plane with respect to the remainder of the horizontal foldable portion 30a. When the horizontal foldable portion 30a is transitioned to a horizontal cuboid 46a, the semicircular tabs 34a, 34b are inserted into the inner space 52a, 52b defined by each of the vertical cuboids 42a, 42b. Insertion of the semicircular tabs 34a, 34b provides additional stability to the integrated canvas and frame in the second configuration (shown in FIG. 5).

As shown in FIG. 4, in some embodiments, the first horizontal cuboid 46a includes a first horizontal foldable section 48a having rounded corners 36a-36b. The rounded corners 36a-36b include semicircular portions of the first horizontal foldable section 48a that extend beyond the second horizontal foldable section 48b. The rounded corners 36a-36b define a portion of the first foldable section 48a sized and configured to be inserted into the slots 44a-44d defined in each of the vertical cuboids 42a, 42b. As shown in FIG. 4, the rounded corners 36a-36b are inserted into the first set of slots 44a-44b to retain the vertical cuboids 42a, 42b and the first horizontal cuboid 46a in fixed positions.

FIG. 5 illustrates the integrated canvas and frame 2 in a second configuration, in accordance with some embodiments. As illustrated in FIG. 5, the second vertical foldable portion 28b is folded at each of the horizontal channels 14d-14f such that the second vertical foldable portion 28a defines a second horizontal cuboid 46b, which is similar to the first horizontal cuboid 46a discussed above. In the illustrated embodiment, the second vertical foldable portion 28b includes foldable sections configured to be positioned at right (e.g., 90°) angles when in the folded position. Although embodiments are discussed herein including a cuboid shape, it will be appreciated that the foldable sections of the vertical foldable portions 28a, 28b may be configured to define any suitable angle therebetween and/or to define any suitable three dimensional shape.

To transition the second horizontal foldable portion 30b to the second horizontal cuboid 46b, each of the horizontal foldable sections 48a-48c of the second horizontal foldable portion 30b are folded at a predetermined angle relative to the next horizontal foldable section 48a-48c and/or relative to the first planar surface 12. For example, in the illustrated embodiment, the second horizontal foldable portion 30b is transitioned to a horizontal cuboid by folding each of the horizontal foldable sections 48a-48c at a 90° angle relative to the next horizontal foldable section 48a-48c and/or relative to the first planar surface 12. Although embodiments are illustrated herein including a 90° fold configured to form a cuboid, it will be appreciated that the relevant angle between each horizontal foldable section 48a-48c and/or the planar surface 12 may include any suitable angle, such as, for example, any angle between 0° and 180°.

Similar to the process described above for the first horizontal cuboid 46a, the semicircular tabs 34c, 34d coupled to the second horizontal cuboid 46b are inserted into the inner space 52a, 52b and the connection tabs 52c, 52d defined by the first horizontal foldable section 48a are inserted into the second set of slots 44c-44d defined in the vertical cuboids 42a, 42b. To transition the second horizontal foldable portion 30b to the second horizontal cuboid 46b, each of the horizontal foldable sections 48a-48c of the second horizontal foldable portion 30b are folded at a predetermined angle relative to the next horizontal foldable section 48a-48c and/or relative to the first planar surface 12. For example, in the illustrated embodiment, the second horizontal foldable portion 30b is transitioned to a horizontal cuboid by folding each of the horizontal foldable sections 48a-48c at a 90° angle relative to the next horizontal foldable section 48a-48c and/or relative to the first planar surface 12. Although embodiments are illustrated herein including a 90° fold configured to form a cuboid, it will be appreciated that the relevant angle between each horizontal foldable section 48a-48c and/or the planar surface 12 may include any suitable angle, such as, for example, any angle between 0° and 180°.

Similar to the process described above for the first horizontal cuboid 46a, the semicircular tabs 34c, 34d coupled to the second horizontal cuboid 46b are inserted into the inner space 52a, 52b and the rounder corners 36c, 36d defined by first horizontal foldable section 48a of the second horizontal foldable portion 28b are inserted into the second set of slots 44c, 44d defined in the vertical cuboids 42a, 42b. The semicircular tabs 34c, 34d coupled to the second horizontal foldable portion 30b are folded out-of-plane with respect to the remainder of the horizontal foldable portion 30b. When the horizontal foldable portion 30b is transitioned to a horizontal cuboid 46b, the semicircular tabs 34c, 34d are inserted into the inner space 52a, 52b defined by each of the vertical cuboids 42a, 42b. Insertion of the semicircular tabs 34c, 34d provides additional stability to the integrated canvas and frame in the second configuration. Similarly, the rounded corners 36c, 36d of the second horizontal foldable portion 30b are inserted into the second set of slots 44c, 44d to retain the vertical cuboids 42a, 42b and the second horizontal cuboid 46b in fixed positions.

When each of the vertical cuboids 42a, 42b and the horizontal cuboids 46a, 46b are formed and coupled together, the integrated canvas and frame 2 is retained in the second configuration in which a frame 60 defines an inset portion 62 including the inner planar area 18. It will be appreciated that the depth of the inset portion 62 is defined by the height of the frame 60, which is defined by the distance between each of the horizontal folds 14a-14f and between each of the vertical folds 16a-16g, as discussed above. In some embodiments, the inset portion 62 defines a medium receiving space sized and configured to receive a medium therein. For example, in some embodiments, a medium such as an acrylic, plastic, rubber, etc. may be poured into the medium receiving space. The medium is contained within the inset portion 62 by the frame 60 and the inner planar area 18.

In some embodiments, the frame 60 includes one or more internal perforations 27a-27d that may be separated and/or removed to define one or more coupling (e.g., hanging) features. For example, in the illustrated embodiment, the frame includes a plurality of internal perforations 27a-27d defining hanging features configured to couple the integrated canvas and frame 2 to a surface (e.g., a wall) with the first planar surface 12 facing the surface. In such a configuration, images and/or other medium added to the second planar surface (not shown) are facing away from the surface and may be “displayed,” e.g., hung on a wall or other surface for viewing. Although embodiments are discussed herein including internal perforations 27a-27d configured to arrange the first planar surface in a facing relationship with the mounting surface, it will be appreciated that one or more internal perforations 27a-27d may be formed in the substantially planar sheet 4 to define mounting features configured to arrange the second planar surface (not shown) in a facing relationship with the mounting surface such that the frame 60 and inner planar surface 18 are facing away from the mounting surface and are “displayed.”

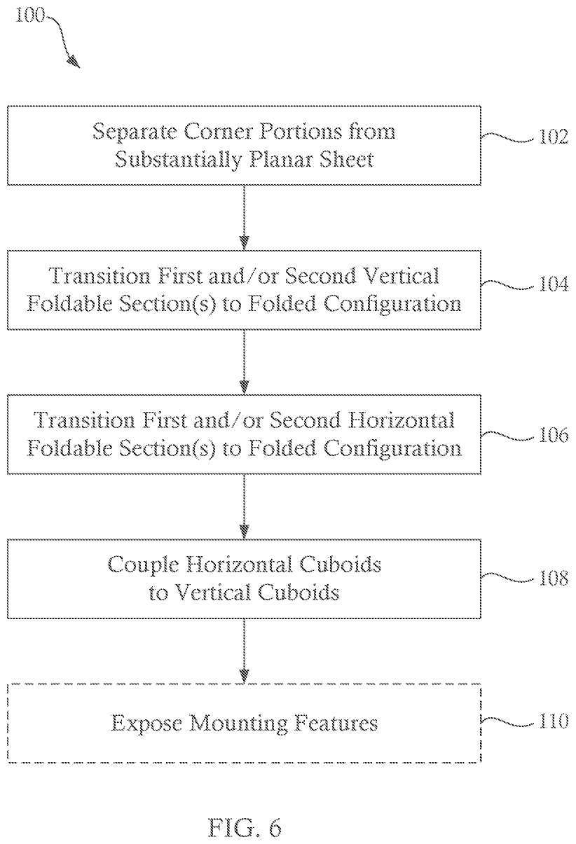

FIG. 6 is a flowchart illustrating a method 100 of transitioning an integrated canvas and frame 2 from a first configuration to a second configuration, in accordance with some embodiments. With reference now to FIGS. 1-6, the method 100 is described. At step 102, one or more corner portions 22a-22d defined by one or more corner perforations 20a-20d are separated from the remainder of a substantially planar sheet, as illustrated in FIGS. 1-2. Removal of the corner portions 22 exposes an internal edge 32a-32c, one or more foldable portions 28a, 28b, 30a, 30b, and one or more coupling features 34a-34c of the integrated canvas and frame 2.

At step 104, a first vertical foldable portion 28a and a second vertical foldable portion 28b are transitioned from a first position, in which the vertical foldable portions 28a, 28b are substantially planar with an inner planar area 18 to a second position, in which the vertical foldable portions 28a, 28b define cuboids 42a, 42b (or some other three-dimensional shape) extending substantially above the inner planar area 18. The vertical foldable portions 28a, 28b may be transitioned to the second position by folding each of the vertical foldable sections 44a-44d of the corresponding vertical foldable portion 28a, 28b at a predetermined angle with respect a prior one of the vertical foldable sections 44a-44d and/or the inner planar surface 18. For example, in the embodiment illustrated in FIG. 3, each of the first and second vertical foldable portions 28a, 28b are transitioned to vertical cuboids 42a, 42b by folding each of the vertical foldable sections 44a-44d at a 90° angle along the vertical channels 16a-16h formed in the substantially planar sheet 4. Although specific embodiments are discussed herein, it will be appreciated that any suitable angle may be used to define any desired three-dimensional shape.

At step 106, a first horizontal foldable portion 30a and a second horizontal foldable portion 30b are transitioned from a first position, in which the horizontal foldable portions 30a, 30b are substantially planar with an inner planar area 18 to a second position, in which the horizontal foldable portions 30a, 30b define horizontal cuboids 46a, 46b (or some other three-dimensional shape) extending substantially above the inner planar area 18. The horizontal foldable portions 30a, 30b may be transitioned to the second position by folding each of the horizontal foldable sections 48a-48c of the corresponding horizontal foldable portion 30a, 30b at a predetermined angle with respect a prior one of the horizontal foldable sections 48a-48c and/or the inner planar surface 18. For example, in the embodiment illustrated in FIG. 4, the first horizontal foldable portion 30a is transitioned to a horizontal cuboid 42a by folding each of the horizontal foldable sections 48a-48c at a 90° angle along the horizontal channels 14a-14c formed in the substantially planar sheet 4. Although specific embodiments are discussed herein, it will be appreciated that any suitable angle may be used to define any desired three-dimensional shape.

In some embodiments, step 106 may further include positioning one or more coupling features formed on and/or coupled to the horizontal cuboids 46a, 46b, such as one or more semicircular tabs 34a-34d, within an internal space 52a, 52b defined by the vertical cuboids 42a, 42b. The semicircular tabs 34a, 34b may be inserted simultaneous with formation of the horizontal cuboids 46a, 46b and/or may be inserted after a horizontal cuboid 46a, 46b is substantially and/or completely defined.

At step 108, the horizontal cuboids 46a, 46b are coupled to the vertical cuboids 42a, 42b to fix the position of each of the horizontal cuboids 46a, 46b and the vertical cuboids 42a, 42b. For example, in the illustrated embodiment, rounded corners 36a-36d defined by the first horizontal foldable section 48a of each of the horizontal foldable portions 30a, 30b are inserted into slots 45a-45d defined in the vertical cuboids 42a, 42b. When the rounder corners 36a-36d are inserted into the corresponding slots 45a-45d, the vertical cuboids 42, 42b and the horizontal cuboids 46a, 46b are maintained in a fixed position to define a frame 60. Although embodiments are discussed herein including a retention (or friction) mechanism for maintain the vertical cuboids 42a, 42b and the horizontal cuboids 46a, 46b in a fixed position, it will be appreciated that additional retention mechanism, such as, for example, an adhesive, may be used.

At optional step 110, one or more internal perforations 27a-27d may be separated and/or removed to define one or more mounting features configured to couple the integrated canvas and frame 2 to a surface. The surface may include, for example, a wall or other vertical surface to allow display of images formed on and/or in the integrated canvas and frame 2.

Although the subject matter has been described in terms of exemplary embodiments, it is not limited thereto. Rather, the appended claims should be construed broadly, to include other variants and embodiments, which may be made by those skilled in the art.

What is claimed is:

1. An integrated canvas and frame, comprising:
a substantially planar sheet having a first plurality of channels and a second plurality of channel formed therein, wherein the first plurality of channels extends substantially along a first axis and the second plurality of channels extends substantially along a second axis, and wherein each channel in the plurality of channels extends from a first planar surface of the substantially planar sheet into the substantially planar sheet;
a plurality of perforations defining a plurality of corner sections, wherein each corner section in the plurality of corner sections is configured to be detached from the substantially planar sheet to define one or more foldable portions of the substantially planar sheet, wherein each of the one or more foldable portions defines a subset of the first plurality of channels or a subset of the second plurality of channels; and
a first plurality of internal perforations formed in at least one of the one or more foldable portions, wherein the plurality of internal perforations define one or more coupling features configured to retain the one or more foldable portions in a folded position.

2. The integrated canvas and frame of claim 1, comprising at least one coupling tab coupled to a first subset of the one or more foldable portions, wherein the at least one coupling tab is sized and configured to be received within an interior volume defined by a second subset of the one or more foldable portions in the folded position.

3. The integrated canvas and frame of claim 1, wherein the first axis and the second axis are substantially perpendicular.

4. The integrated canvas and frame of claim 1, wherein the one or more foldable portions comprises a first set of foldable portions and a second set of foldable portions.

5. The integrated canvas and frame of claim 4, wherein each foldable portion in each of the first set of foldable portions and the second set of foldable portions is configured to define a cuboid in the folded position.

6. The integrated canvas and frame of claim 1, comprising a second plurality of internal perforations formed in at least one of the one or more foldable portions, wherein each of the second plurality of perforations defines at coupling feature configured to couple the substantially planar sheet to a surface when the at least one of the one or more foldable portions including the second plurality of internal perforations is in the folded position.

7. The integrated canvas and frame of claim 1, wherein the first plurality of channels includes a first set of channels positioned adjacent to a first edge of the substantially planar sheet extending along the first axis and a second set of channels positioned adjacent to a second edge of the substantially planar sheet extending along the first axis.

8. The integrated canvas and frame of claim 7, wherein the second plurality of channels includes a first set of channels positioned adjacent to a third edge of the substantially planar sheet extending substantially along the second axis and a second set of channels positioned adjacent to a fourth edge of the substantially planar sheet extending substantially along the second axis.

9. The integrated canvas and frame of claim 7, wherein the first set of channels includes a first channel positioned a first distance from the first edge of the substantially planar sheet, a second channel positioned a second distance from the first channel, and a third channel positioned the first distance from the second channel.

10. The integrated canvas and frame of claim 9, wherein the first distance and the second distance are equal.

11. An integrated canvas and frame, comprising:
a substantially planar sheet defined by at least a first edge, a second edge, a third edge, and a fourth edge, wherein the first edge and the second edge extend substantially along a first axis and the third edge and the fourth edge extend substantially along a second axis;
a first set of channels formed adjacent to the first edge, the first set of channels comprising a first channel positioned a first distance from the first edge, a second channel positioned a second distance from the first channel, a third channel positioned the first distance from the second channel, and a fourth channel positioned the second distance from the third channel, wherein each of the first channel, the second channel, the third channel, and the fourth channel extend substantially along the first axis;
a second set of channels formed adjacent to the second edge, the second set of channels comprising a fifth channel positioned the first distance from the second edge, a sixth channel positioned the second distance from the fifth channel, a seventh channel positioned the first distance from the sixth channel, and an eighth channel positioned the second distance from the fourth channel, wherein each of the fifth channel, the sixth channel, the seventh channel, and the eighth channel extend substantially along the first axis;
a third set of channels formed adjacent to the third edge, the third set of channels comprising a ninth channel positioned a third distance from the third edge, a tenth channel positioned a fourth distance from the ninth channel, and an eleventh channel positioned the third distance from the tenth channel, wherein each of the ninth channel, the tenth channel, and the eleventh channel extend substantially along the second axis; and
a fourth set of channels formed adjacent to the fourth edge, the fourth set of channels comprising a twelfth channel positioned the third distance from the third edge, a thirteenth channel positioned the fourth distance from the twelfth channel, and a fourteenth channel positioned the third distance from the thirteenth channel, wherein each of the twelfth channel, the thirteenth channel, and the fourteenth channel extend substantially along the second axis;
wherein each of the first set of channels, the second set of channels, the third set of channels, and the fourth set of channels define positions at which a portion of the substantially planar surface can be transitioned from a first, planar configuration to a second configuration defining one or more cuboids.

12. The integrated canvas and frame of claim 11, wherein the first distance and the second distance are equal.

13. The integrated canvas and frame of claim 11, wherein the first distance and the third distance are equal and the second distance and the fourth distance are equal.

14. The integrated canvas and frame of claim 11, wherein the first axis and the second axis are substantially perpendicular.

15. A method, comprising:
obtaining a substantially planar sheet having a first plurality of channels and a second plurality of channel formed therein, wherein the first plurality of channels extends substantially along a first axis and the second plurality of channels extends substantially along a second axis, and wherein each channel in the plurality of channels extends from a first planar surface of the substantially planar sheet into the substantially planar sheet;
separating a plurality of corner portions from the substantially planar sheet to expose a plurality of foldable portions, wherein each of the plurality of foldable portions includes a subset of the first plurality of channels or a subset of the second plurality of channels;
transitioning each of the plurality of foldable portions to a folded configuration in which each of the plurality of foldable portions defines a three-dimensional shape, wherein each of the plurality of foldable portions is transitioned to the folded configuration by folding a respective foldable portion at each channel in the subset of the first plurality of channels or the subset of the second plurality of channels included in the respective foldable portion;
coupling two or more of the plurality of foldable portions to maintain each of the plurality of foldable portions in the folded configuration.

16. The method of claim 15, wherein coupling two or more of the plurality of foldable portions comprises inserting a portion of a first foldable portion into one or more slots defined in at least a second foldable portion.

17. The method of claim 15, wherein coupling two or more of the plurality of foldable portions comprises inserting a tab defined by a first foldable portion into an inner space defined by at least a second foldable portion.

18. The method of claim 15, wherein separating a plurality of corner portions from the substantially planar sheet comprises separating one or more perforations formed in the substantially planar sheet to release the plurality of corner portions.

19. The method of claim 15, wherein each of the plurality of foldable portions define a cuboid in the folded configuration.

20. The method of claim 15, wherein the first axis and the second axis are substantially perpendicular.
